(19) United States
(12) Patent Application Publication
(10) Pub. No.: US 2006/0023336 A1
(43) Pub. Date: Feb. 2, 2006

(54) Cleaning read/write heads of a magnetic tape recording system

(76) Inventors: Nigel Ronald Evans, Bristol (GB); John Mark Mackelden, Chippenham (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/191,555

(22) Filed: Jul. 28, 2005

(30) Foreign Application Priority Data
Jul. 29, 2004 (GB) 0416911.6

(51) Int. Cl. G11B 19/02; G11B 27/36; G11B 5/09; G11B 21/02

(52) U.S. Cl. 360/69; 360/53; 360/31; 360/75

(57) ABSTRACT

One embodiment of a method is provided of cleaning one or more read/write heads of a magnetic tape recording system using a magnetically recordable cleaning tape in the system. An initial target error rate is registered in the system. The system performs a cleaning operation including pulling a portion of the cleaning tape through the system so as to clean the or each head. Test data is recorded onto the cleaning tape by means of the or each head as the tape is being pulled through the system and a read-while-write check is performed on the test data to calculate the error rate of the test data. The system is instructed to perform another cleaning operation if the calculated error rate is above the target error rate. Other methods and systems are also provided.

### CLAIM TO PRIORITY

This application claims priority to copending United Kingdom utility application entitled, “CLEANING READ/WRITE HEADS OF A MAGNETIC TAPE RECORDING SYSTEM,” having serial no. GB 0416911.6, filed Jul. 29, 2004, which is entirely incorporated herein by reference.

### TECHNICAL FIELD

The present disclosure relates to cleaning one or more read/write heads of a magnetic tape recording system by means of a cleaning tape.

### BACKGROUND

A common form of storage medium for use in storing computer data takes the form of a magnetically recordable tape that is moved relative to magnetic read/write heads. One form of magnetic tape data recording system comprises a helical-scan tape deck in which the tape from a tape cartridge passes at a predetermined angle across a rotary head drum. In operation, the tape is drawn from a supply reel to a take-up reel by rotation of a capstan against which the tape is pressed by a pinch roller. The head drum houses two write heads angularly spaced by 180° and two read heads also angularly spaced by 180°.

The magnetic tape is subject to wear and deterioration and the recording system is subject to head clogs. The result is that errors occur in the read/write process. Whilst some errors can be corrected by a format of data encoding that includes error correction within the format definition, nevertheless, it is necessary to take steps to clean the read/write heads, so that errors that are attributable to dirty heads are eliminated or reduced.

It is already known to clean the magnetic read/write heads by inserting a cleaning tape cartridge into such a magnetic data recording system. The cleaning tape cartridge contains a cleaning tape that has no recorded data but is pulled through the data recording system to clean the heads. The cleaning tape is advanced by a chosen increment to clean the heads. The increment of cleaning tape that is pulled through the data recording system is contaminated by the cleaning process and cannot be re-used. A fresh increment of the cleaning tape must be advanced when a cleaning operation is performed the next time.

A disadvantage of the conventional method of cleaning the heads of the data recording system by a cleaning tape is that there is no indication of how effective the cleaning operation has been until a data recording tape has been inserted into the system and data recording has been undertaken. This may result in the situation where an unsatisfactory cleaning operation has resulted, and the cleaning operation has to be repeated all over again. Alternatively, the length of cleaning tape that is incremented to clean the heads is deliberately chosen to be longer than necessary for a successful cleaning operation in an attempt to ensure the success of the cleaning operation. This may result in wastage of the cleaning tape.

It has already been proposed in U.S. Pat. No. 5,381,292, which is incorporated herein in its entirety, to clean a section of a magnetic tape where read/write errors occur. In a first step, the tape is spooled to one end of the tape at 300 times the normal read or write speed. In a second step, the tape is spooled to the other end of the tape at 300 times the normal read or write speed. In the third step, the tape is moved to place the heads over the section where the errors occurred.

It has also been proposed in published U.S. patent application 20030169529, which is incorporated herein in its entirety, to use a cleaning cartridge in a magnetic recording system, the cleaning tape having a pattern signal recorded on a predetermined segment that is read by a magnetic head in the system. On-site adjustments can be made to parameters of the magnetic head by reading the pattern from the cleaning tape, when the user directs a cleaning operation. A failure of the magnetic head can also be detected and predicted through the cleaning operation.

### SUMMARY

According to the one embodiment of the present disclosure, there is now provided a method of cleaning one or more read/write heads of a magnetic tape recording system, the method comprising: setting a magnetically recordable cleaning tape in the system; registering a target error rate; instructing the system to perform a cleaning operation including pulling a portion of the cleaning tape through the system so as to clean the or each head; recording test data onto the cleaning tape by means of the or each head as the portion of the tape is being pulled through the system and performing a read-while-write check on the test data to calculate the error rate of the test data; and instructing the system to perform another cleaning operation if the calculated error rate is above the target error rate.

In one embodiment, the method includes the further step of pulling an initial portion of the tape through the system and calculating an initial error rate. The target error rate may be a value referenced to the initial error rate.

Further, according to the one embodiment, there is provided a magnetic recording system having one or more read/write heads and adapted to receive a magnetically recordable cleaning tape, the system being programmed: to register a target error rate; to perform a cleaning operation that includes pulling a portion of the cleaning tape through the system so as to clean the or each head, recording test data onto the cleaning tape by means of the or each head as the portion of the tape is pulled through the system, and performing a read-while-write check on the test data to calculate the error rate of the test data, the system being further programmed to perform another cleaning operation if the calculated error rate is above the target error rate.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Embodiments of the present disclosure will now be described, by way of example only, by reference to the accompanying drawings in which:

FIG. 1 shows a block diagram of the components of a magnetic tape recording system embodying one embodiment of the present disclosure;

FIG. 2 shows the main physical components of a tape deck included in the system of FIG. 1;

FIG. 3 is a diagrammatic representation of two data tracks recorded on a tape by means of the tape deck of FIG. 2;

FIG. 4 is a flow diagram of steps used in one embodiment of a method of the present disclosure; and

FIG. 5 is a flow diagram of further steps used in one embodiment of a method of the present disclosure.

### DETAILED DESCRIPTION

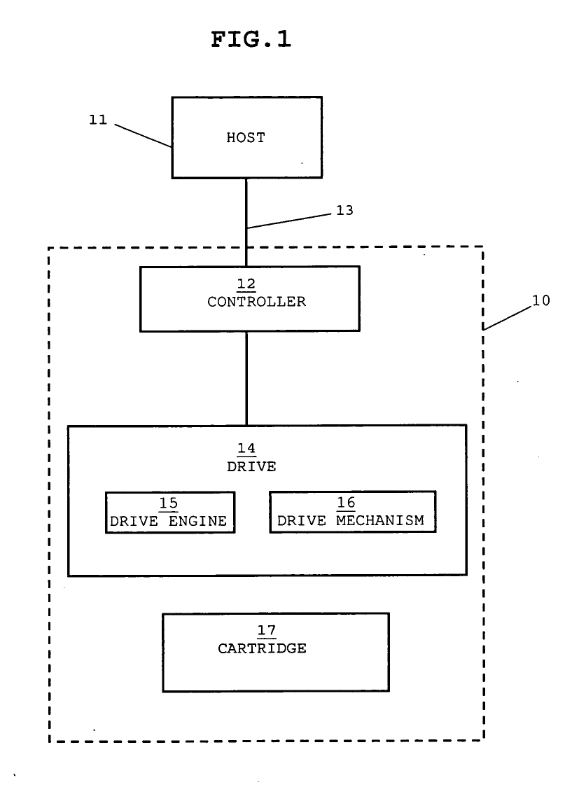

Referring to FIG. 1, there is shown a data storage system 10 embodying one embodiment of the present disclosure. The system includes a host 11 coupled to a controller 12 via an interface 13. The controller 12 is programmed to control a tape drive 14 that includes a drive engine 15 and a drive mechanism 16. The drive mechanism is adapted to receive a tape cartridge 17. A controlling software application on the host 11 controls the reading and writing of data on a magnetic data tape in the tape cartridge 17.

The host system 11 has at least one central processing unit (CPU) and a memory to store the controlling software application. The interface 13 connecting the host system 11 to the controller 12 may be any suitable proprietary standard bus known to those skilled in the art.

The drive mechanism 16 includes electrical and mechanical components that receive, position, and access tape cartridges. The drive mechanism has components to lock a tape cartridge in place, an ejection motor, and read/write heads. The drive engine 15 is a data processor that is programmed to supervise the operations of the drive mechanism 16 and to manage the flow of data to be recorded in or read from a tape cartridge 17 received in the drive 14. A cleaning cartridge that stores a cleaning tape may be loaded in the drive 14 to affect cleaning of the read/write heads. The drive engine 15 has a program to control the process of cleaning the read/write heads by means of the cleaning tape as will be explained in greater detail below. The drive engine 15 is programmed to calculate and register the error rate of data that is recorded on a tape cartridge that is loaded in the drive 14.

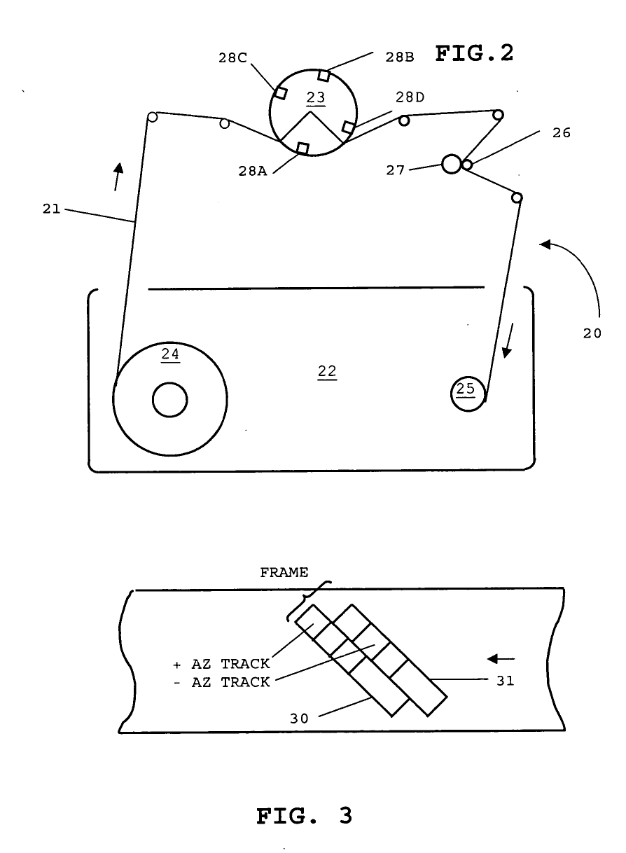

Referring to FIG. 2, there is shown the basic layout of the tape drive 14 which is in the form of a helical-scan tape deck 20 in which tape 21 from a tape cartridge 22 passes at an angle across a rotary head drum 23. The tape is driven in the direction indicated by the arrows from a motor driven supply reel 24 to a motor driven take up reel 25. A capstan 26 and pinch roller 27 control the passage of the tape past the head drum 23. The rotary head drum 23 carries two magnetic write heads 28A and 28B spaced apart by 180° and two magnetic read heads 28C and 28D also spaced apart by 180°. The heads 28A and 28B are arranged to write a succession of overlapping oblique data tracks 30, 31 on the tape, as shown in FIG. 3. The two tracks 30, 31 are representative of a succession of tracks along the tape that are recorded in a manner well known in the art. The track written by the head 28A has a positive azimuth, while the track written by the head 28B has a negative azimuth. Each pair of positive and negative azimuth tracks 30,31 constitutes a frame.

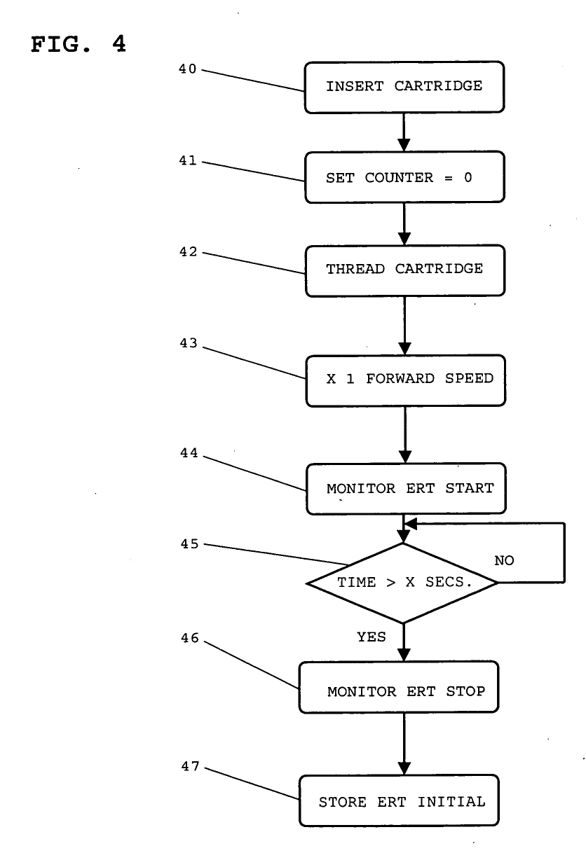

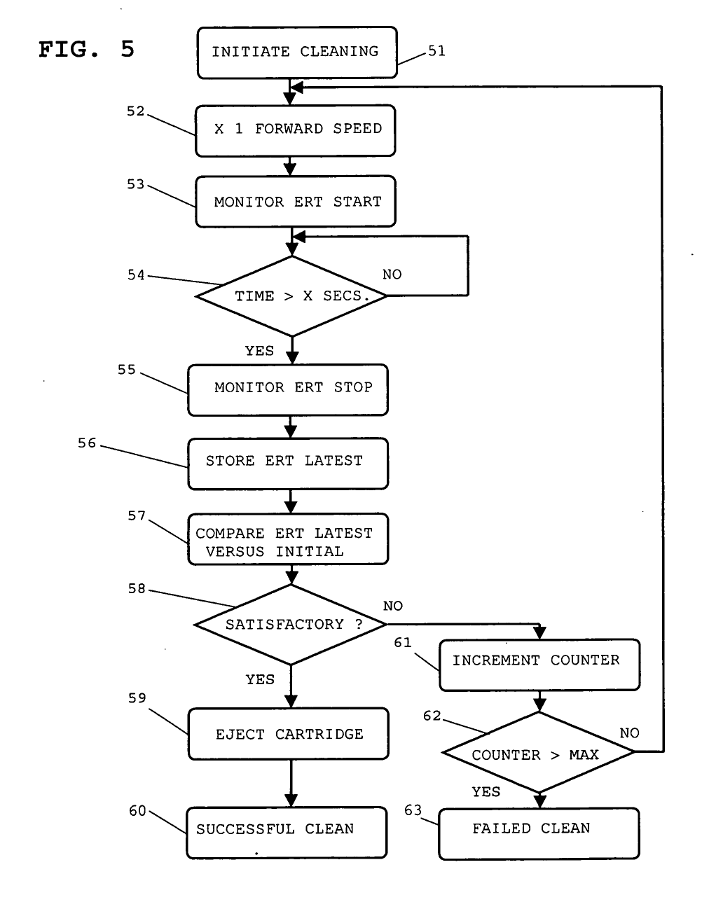

FIG. 4 shows an initial preparatory sequence of steps that is taken to clean the heads 28A, 28B, 28C and 28D by means of a cleaning tape. In step 40, a cleaning cartridge including the cleaning tape is loaded in the tape drive 14. A counter in the controller 12 is set to zero in step 41, to indicate that this is a preparatory phase of a cleaning operation. In step 42, the cleaning tape in the cleaning cartridge is threaded through the tape drive 14. The cleaning tape is a magnetically recordable tape on which the heads 28A and 28B can record data in the manner already described and illustrated in FIGS. 2 and 3.

In step 43, the cleaning tape is advanced at the normal recording speed, clearing any previously recorded area on the tape, so that a pristine length of cleaning tape is presented to the heads 28A, 28B, 28C and 28D. The write heads 28A and 28B record a sequence of test data on the cleaning tape. The test data is recorded so that an initial error rate for the recording system can be determined from the test data and registered by means of the drive engine 15. In step 44, the start time of the error rate test is monitored. A check is performed, in step 45, to determine whether the cleaning tape has been incremented for a time up to the end of a fixed test interval of X seconds. The initial error rate of the recorded test data is determined in step 46 and stored in step 47, by means of the drive engine 15.

Referring now to FIG. 5, in step 51, cleaning of the heads 28A, 28B, 28C and 28D is initiated by backwards and forwards motion of the tape after the initial error rate has been derived and registered by means of the sequence of steps shown in FIG. 4. As will be described, the initial error rate is used as a reference from which to determine the degree of success achieved in cleaning the heads.

In step 52, the cleaning tape is advanced at the normal recording speed, clearing the previously recorded area on the tape, so that the next pristine length of cleaning tape is presented to the heads 28A, 28B, 28C, and 28D. The heads 28A and 28B again record a sequence of test data on the cleaning tape. In step 53, the start time of an error rate test is monitored. A check is performed in step 54, to determine whether the cleaning tape has been incremented for a time up to the end of the fixed test interval of X seconds. The error rate of the recorded test data is determined in step 55 and stored in step 56 by means of the drive engine 15.

In step 57, the error rate stored in step 56 is compared with the initial error rate stored in step 47, to determine the extent to which the error rate has improved as a result of the cleaning operation. A value representing that improvement by reference to the initial error rate is generated in step 57. A check is made in step 58 to determine if the value generated in step 57 represents a drop in the error rate down to a target value that is referenced to the initial error rate. If so, the cleaning cartridge is ejected from the drive 14, in step 59. An indication of a successful cleaning operation is provided in step 60 to an operator of the system 10.

If the check performed in the step 58 shows that the drop in the error rate has not reached the target value, the process continues to step 61, where the counter initially set to zero in step 41 is incremented by one. The process then continues to step 62, where a check is made on the number to which the counter has been incremented. If the counter has been incremented to a value less than a maximum preset value, the process returns to step 52, and the cleaning cartridge is advanced once again to perform a new cleaning operation. The new cleaning operation may be a repeat of the previous cleaning operation, including the same sequence of steps as the previous operation. Alternatively, the new cleaning operation may be a modified cleaning operation in which, for example, a greater length of cleaning tape is advanced to perform the new cleaning operation. In yet another alternative, the new cleaning operation may involve a greater number of backwards and forwards motions of the cleaning tape.

If the check performed in step 62 shows that the counter has been incremented to its maximum value, the process moves on to step 63. In step 63, an error flag is set to indicate a failed cleaning operation. This flag can be read by the host 11, if desired, whereby the host will be informed that the clean attempt has failed.

In an alternative embodiment, the check carried out in step 58 may be a check to determine if the error rate calculated in step 57 is below a fixed predetermined target value for the error rate. In this case, the target value is not referenced to an initial value of error rate but is an absolute value. In this case also, steps 43 to 47 may be dispensed with, since an initial value of error rate is not required.

What has been described is an embodiment of a method of cleaning the read/write heads of a magnetic tape data recording system by means of a magnetically recordable cleaning tape. A target error rate is registered in the system and a portion of the cleaning tape is pulled through the system, so as to clean the or each head. Test data is recorded onto the cleaning tape by means of the or each head as the portion of the tape is being pulled through the system and a read-while-write check is performed on the test data. The error rate of the test data is calculated, and the system is instructed to perform another cleaning operation if the calculated error rate is above the target error rate.

It should be emphasized that the above-described embodiments of the present disclosure are merely possible examples of implementations, merely set forth for a clear understanding of the principles of the disclosure. Many variations and modifications may be made to the above-described embodiments without departing substantially from the spirit and principles of the present disclosure. All such modifications and variations are intended to be included herein within the scope of this disclosure.

Therefore, having thus described the invention, at least the following is claimed:

1. A method of cleaning at least one read/write head of a magnetic tape recording system, the method comprising:
setting a magnetically recordable cleaning tape in the system;
registering a target error rate;
instructing the system to perform a first cleaning operation that includes pulling a portion of the cleaning tape through the system so as to clean the head, recording test data onto the cleaning tape by means of the head as the portion of the tape is being pulled through the system, and performing a read-while-write check on the test data to calculate the error rate of the test data; and
instructing the system to repeat the first cleaning operation if the calculated error rate is above the target error rate.

2. A method of cleaning at least one read/write head of a magnetic tape recording system, the method comprising:
setting a magnetically recordable cleaning tape in the system;
registering a target error rate;
instructing the system to perform a first cleaning operation that includes pulling a portion of the cleaning tape through the system so as to clean the head, recording test data onto the cleaning tape by means of the head as the portion of the tape is being pulled through the system, and performing a read-while-write check on the test data to calculate the error rate of the test data; and
instructing the system to perform a modification of the first cleaning operation if the calculated error rate is above the target error rate.

3. A method of cleaning at least one read/write head of a magnetic tape recording system, the method comprising:
setting a magnetically recordable cleaning tape in the system;
registering a target error rate;
instructing the system to perform a first cleaning operation that includes pulling a portion of the cleaning tape through the system so as to clean the head, recording test data onto the cleaning tape by means of the head as the portion of the tape is being pulled through the system, and performing a read-while-write check on the test data to calculate the error rate of the test data; and
instructing the system to perform another cleaning operation if the calculated error rate is above the target error rate.

4. The method as claimed in claim 2, in which the modification of the first cleaning operation employs an increased length of the cleaning tape compared to the first cleaning operation.

5. The method as claimed in claim 1, comprising the further step of pulling an initial portion of the tape through the system and calculating an initial error rate.

6. The method as claimed in claim 2, comprising the further step of pulling an initial portion of the tape through the system and calculating an initial error rate.

7. The method as claimed in claim 3, comprising the further step of pulling an initial portion of the tape through the system and calculating an initial error rate.

8. The method as claimed in claim 5, wherein the target error rate is a value referenced to the initial error rate.

9. The method as claimed in claim 6, wherein the target error rate is a value referenced to the initial error rate.

10. The method as claimed in claim 7, wherein the target error rate is a value referenced to the initial error rate.

11. A method of cleaning a read/write head of a magnetic tape recording system, the method comprising:
setting a magnetically recordable cleaning tape in the system,
registering a predetermined target error rate,
instructing the system to perform a first cleaning operation that includes pulling a portion of the cleaning tape through the system so as to clean the head, recording test data onto the cleaning tape by means of the head as the portion of the tape is being pulled through the system and performing a read-while-write check on the test data to calculate the error rate of the test data, and
instructing the system to perform another cleaning operation if the calculated error rate is above the predetermined target error rate.

12. The method as claimed in claim 11, in which the step of instructing the system to perform another cleaning operation if the calculated error rate is above the predetermined target error rate comprises instructing the system to repeat the first cleaning operation.

13. A method of cleaning at least one read/write head of a magnetic tape recording system, the method comprising:
setting a magnetically recordable cleaning tape in the system;
a registering a target error rate;
instructing the system to perform a first cleaning operation that includes pulling a portion of the cleaning tape through the system so as to clean the head, recording test data onto the cleaning tape by means of the head as the portion of the tape is being pulled through the system and performing a read-while-write check on the test data to calculate the error rate of the test data; and
instructing the system to perform cleaning operations until the calculated error rate of the test data is below the target error rate.

14. The method as claimed in claim 13, wherein the step of performing cleaning operations until the calculated error rate of the test data is below the target error rate is terminated if the cleaning operations have been performed a predetermined number of times.

15. A magnetic recording system having at least one read/write head and adapted to receive a magnetically recordable cleaning tape, the system being programmed:
to register a target error rate; and
to perform a cleaning operation that includes pulling a portion of the cleaning tape through the system so as to clean the head, recording test data onto the cleaning tape by means of the head as the portion of the tape is pulled through the system, and performing a read-while-write check on the test data to calculate the error rate of the test data, the system being further programmed to perform another cleaning operation if the calculated error rate is above the target error rate.

16. The system as claimed in claim 15, which is programmed to repeat the first cleaning operation if the calculated error rate is above the target error rate.

17. The system as claimed in claim 15, which is programmed to perform a modification of the first cleaning operation if the calculated error rate is above the target error rate.

18. The system as claimed in claim 17, in which the modification of the first cleaning operation employs an increased length of the cleaning tape compared to the first cleaning operation.

19. The system as claimed in claim 15, the system being further programmed to pull an initial portion of the tape through the system and to calculate an initial error rate.

20. The system as claimed in claim 16, the system being further programmed to pull an initial portion of the tape through the system and to calculate an initial error rate.

21. The system as claimed in claim 17, the system being further programmed to pull an initial portion of the tape through the system and to calculate an initial error rate.

22. The system as claimed in claim 19, wherein the target error rate is a value referenced to the initial error rate.

23. The system as claimed in claim 20, wherein the target error rate is a value referenced to the initial error rate.

24. The system as claimed in claim 21, wherein the target error rate is a value referenced to the initial error rate.

25. A magnetic recording system having a read/write head of and adapted to receive a magnetically recordable cleaning tape, the system being programmed:
to register a predetermined target error rate;
to perform a first cleaning operation that includes pulling a portion of the cleaning tape through the system so as to clean the head, recording test data onto the cleaning tape by means of the head as the portion of the tape is being pulled through the system, and performing a read-while-write check on the test data to calculate the error rate of the test data; and
to perform another cleaning operation if the calculated error rate is above the predetermined target error rate.

26. A magnetic recording system having at least one read/write head and adapted to receive a magnetically recordable cleaning tape, the system being programmed:
to register a target error rate;
to perform a cleaning operation that includes pulling a portion of the cleaning tape through the system so as to clean the head, recording test data onto the cleaning tape by means of the head as the portion of the tape is pulled through the system, and performing a read-while-write check on the test data to calculate the error rate of the test data, the system being further programmed to perform cleaning operations until the calculated error rate of the test data is below the target error rate.

27. The system as claimed in claim 26, wherein the system is instructed to perform cleaning operations until the cleaning operations have been performed a predetermined number of times.

28. A computer program for controlling a magnetic recording system having at least one read/write head and adapted to receive a magnetically recordable cleaning tape, the program, when loaded in the system, being effective to cause the system:
to register a target error rate;
to perform a cleaning operation that includes pulling a portion of the cleaning tape through the system so as to clean the head, recording test data onto the cleaning tape by means of the head as the portion of the tape is pulled through the system, and performing a read-while-write check on the test data to calculate the error rate of the test data; and
to perform another cleaning operation if the calculated error rate is above the target error rate.
